(19) United States
(12) Patent Application Publication
(10) Pub. No.: US 2009/0059802 A1
(43) Pub. Date: Mar. 5, 2009

(54) DEVICE, SYSTEM AND METHOD FOR DIAGNOSING INTERWORKING FAULT OF X DIGITAL SUBSCRIBER LINE TRANSCEIVERS

(76) Inventors: Hao Zhang, Shenzhen (CN); Binfeng Wang, Shenzhen (CN); Linzhi Yan, Shenzhen (CN); Liyuan Song, Shenzhen (CN); Jian Zhang, Shenzhen (CN); Zhongyu Lin, Shenzhen (CN); Jingfeng Wang, Shenzhen (CN)

Correspondence Address: BRINKS HOFER GILSON & LIONE, P.O. BOX 10395, CHICAGO, IL, 60610, US

(21) Appl. No.: 12/268,710

(22) Filed: Nov. 11, 2008

Related U.S. Application Data
(63) Continuation of application No. PCT/CN2007/001605, filed on May 17, 2007.

(30) Foreign Application Priority Data
Aug. 11, 2006 (CN) 200610062118.2

(51) Int. Cl. H04L 12/26

(52) U.S. Cl. 370/242

(57) ABSTRACT

A device, system and method for diagnosing an interworking fault of x Digital Subscriber Line (xDSL) transceivers are disclosed. The xDSL transceivers in the system include an xTU-C and an xTU-R. The system further includes: a message collection module adapted to collect and save the interaction messages transmitted between the xTU-C and the xTU-R during the activation of an xDSL line; and a fault analysis module adapted to analyze the collected interaction messages to obtain the first diagnosis conclusion with respect to the interworking fault.

### CROSS-REFERENCE TO RELATED APPLICATIONS

This is a continuation of PCT application No. PCT/CN2007/001605, field May 17, 2007, title “DEVICE, SYSTEM AND METHOD FOR DIAGNOSING INTERWORKING FAULT OF X DIGITAL SUBSCRIBER LINE TRANSCEIVERS”, which claims priority of Chinese Patent Application No. 200610062118.2, filed on Aug. 11, 2006, entitled “System and Method for Diagnosing Interworking Fault of x Digital Subscriber Line Transceivers”, the contents of both of which are incorporated herein by reference in its entirety.

### FIELD

The present embodiments relate to a system and method for diagnosing a communication device, and in particular to a device, system and method for diagnosing an interworking fault of x Digital Subscriber Line (xDSL) transceivers.

### BACKGROUND

xDSL is the total name of various kinds of DSLs, and is a high-speed data transmission technology using a telephone twisted-pair (Unshielded Twist Pair, UTP) to perform transmission. Other than a baseband transmission DSL, such as an ISDN Digital Subscriber Line (IDSL) and a Single-pair High Speed DSL (SHDSL), with a passband transmission xDSL, the xDSL service and the Plain Ordinary Telephone Switching (POTS) service can coexist in the same twisted line by using the Frequency Division Multiplexing technology. Here, the xDSL service occupies a high frequency band, and the POST service occupies a baseband below 25 KHz, and the POTS signal and the xDSL signal are split by a splitter. The passband transmission xDSL employs the Discrete Multi Tone (DMT) modulation. A system allowing multiple xDSLs to access is referred to as a DSL Access Multiplexer (DSLAM), a reference system model of which is shown as FIG. 1. Both a Central Office and a terminal (i.e. a remote end) need to separate a low frequency signal of the POTS from a high frequency signal of the xDSL through a splitter. An activation training interaction process defined by a standard is performed on the xDSL by transceiver units of the Central Office and the terminal, and the transceiver units are capable of data communicating once the activation succeeds.

The development of the xDSL technology has been so fast that it is only four or five years from the beginning of ADSL to the time that ADSL2+ has arisen. It has been expected that the Very-high-bit-rate Digital Subscriber Line 2 (VDSL2) mature and be in commercial use in the end of 2006 or the beginning of 2007. Thus, the ADSL, ADSL2/2+ and VDSL2 will coexist in the Central Office devices in the network. The existing Remote xDSL Terminal Unit (xTU-R) for the ADSL and ADSL2+ in the network may still be in use. Since the ADSL/ADSL2+ technology is significantly different from the VDSL2 technology not only in the speed (the maximum downstream rate of the ADSL is 8M and the maximum downstream rate of the ADSL2+ is 24M, whereas a symmetrical achievable rate of the VDSL is approximately 100M), but also in some characteristic parameters such as Power Spectrum Density (PSD) shaping and spectrum notching. In order to implement the coexistence of various modes of the xDSL transceivers (including a Central Office xDSL Terminal Unit (xTU-C) and xTU-R), a later Central Office device is required to be compatible with the previous mode, that is, to support a plurality of xDSL modes.

During an activation process, i.e. an initialization process, an xTU-C and an xTU-R measure and analyze conditions of a channel, then negotiate parameters required for establishing a connection in accordance with a certain rule, and finally establish a connection according to the negotiation result. Taking an activation process for the VDSL2 as an example, the initialization procedure of the xDSL is shown in FIG. 2. An xDSL transceiver undergoes phases of handshake, channel discovery, training, channel analysis and exchange (together referred to as an initialization process or an activation process) from being startup to a normal operation status, and finally reaches the normal operation status (Show Time). Upon accomplishing the initialization process, the xTU-C and xTU-R enter a normal operation status phase to transmit service data.

Different information exchanged between an xTU-C and an xTU-R during the xDSL activation process is distinguished with different kinds of messages, which are described respectively in detail in the corresponding xDSL standards. During the activation process, an operation mode, a line transmission parameter, a framing parameter, and supportable properties that are necessary to transmit the xDSL service are finally determined through message exchanging.

An entire activation process is very complicated, and any error in time length or a signal transmitted in any phase may lead to a fault. Further, mutual influence exists on the parameters exchanged, and a certain relationship between the parameters needs to be satisfied; otherwise, an interworking fault may also occur. Because various manufacturers of an xDSL chip or device have different understandings for respective xDSL standards, and support the xDSL standards to different extents, a lot of interworking faults between an xTU-C and an xTU-R will occur in practice in particular with a commercial use of the VDSL2. The interworking faults mainly include: a failure of normal activation, an unstable activation, easy to drop, an unideal activation parameter, for example, a very low rate of an activated line.

For the interworking fault between the xTU-C and the xTU-R, there are the following two solutions in the prior art.

One technical solution in the prior art is described in below as follows.

Presently, a commercial DSLAM device typically offers a way of viewing remotely a log of the device. The device maintenance personnel log on the device remotely, view an operation log and an alarm log recorded in the device, and analyze the personnel operation record and the abnormal situation record of the device when a certain xDSL line fails (for example, which service line fails, and if any abnormality exists in the line status changes and the traffic). However, the existing way of locating a fault by checking a log has a limited function in that generally only a fault due to an incorrect operation on the device by unskilled personnel can be diagnosed, or device status when a fault occurs is to be recorded for assisting maintenance personnel to reproduce the fault, and then a diagnosis is performed in another way. Such technology can not be used to automatically analyze the collected data to come up with a conclusion, and it requires a high level of technology experience for maintenance personnel, resulting in low efficiency. This technology can not be used to diagnose an interworking fault of xDSL transceivers caused by the device itself, and can not determine whether a fault of a Central Office device or that of a terminal device leads to an activation failure for both the Central Office device and the terminal device.

Another solution in the prior art is described in below as follows.

In the case that a fault occurs to an xDSL transceiver operating in a global telecommunication broadband access network, if it is determined that this failure is due to an interworking fault instead of an interference of the line environment or a mistake in manual manipulation, the current diagnosing technology includes: collecting information to analyze by personnel being familiar with the ADSL/VDSL related standards and interaction information at the accident scene; or analyzing and locating the failure by reproducing it, with the Central Office xDSL line card device or xTU-R device delivered to the manufacturer. This needs a special debugging tool to be connected to the device to collect data in real time, and analysis is performed with experience by referring to standards. In this solution, it requires an engineer diagnosing the fault in technology, the cost for transporting personnel and materials is high. Further, a debugging tool needs to be connected to the device. Generally, diagnosis of an interworking fault of a certain xDSL subscriber line may result in an interruption of normal service of other subscriber line. Such diagnosis of an interworking fault of the xDSL is low in efficiency, which is disadvantageous for both device provider and operator.

### SUMMARY

The embodiments provide a device, a system, and a method for diagnosing an interworking fault of x Digital Subscriber Line (xDSL) transceivers to enable device maintenance personnel to locate and resolve the interworking fault of xDSL transceivers rapidly and effectively.

An xDSL transceiver comprises a message collection module adapted to collect and save an interaction message transmitted between a Central Office xDSL Terminal unit (xTU-C) and a Remote xDSL Terminal Unit (xTU-R) during an activation process for an xDSL line; and a fault analysis module adapted to analyze the collected interaction message to come up with a first diagnosis conclusion with respect to interworking fault.

An xDSL transceive includes a message collection module adapted to collect and save an interaction message transmitted between a Central Office xDSL Terminal unit (xTU-C) and a Remote xDSL Terminal Unit (xTU-R) during an activation process for an xDSL line; and a preliminary fault analysis module adapted to analyze preliminarily the collected interaction message to come up with a second diagnosis conclusion with respect to interworking fault.

A system for diagnosing an interworking fault of xDSL transceivers includes xDSL transceivers. The xDSL transceivers include an xTU-C and an xTU-R. The system further includes a message collection module and a fault analysis module.

The message collection module is adapted to collect and save an interaction message transmitted between an xTU-C and an xTU-R during an activation of an xDSL line;

The fault analysis module is adapted to analyze the collected interaction message to come up with a first diagnosis conclusion with respect to an interworking fault.

A method for diagnosing an interworking fault of xDSL transceivers is provided, including the following steps: collecting and saving an interaction message transmitted between an xTU-C and an xTU-R during an activation of an xDSL line; and analyzing the collected interaction message to come up with a first diagnosis conclusion with respect to an interworking fault.

The interaction message transmitted between an xTU-C and an xTU-R during an activation can be collected and saved by the message collection module, and the collected interaction message is analyzed by the fault analysis module, so as to come up with a first diagnosis conclusion with respect to an interworking fault. Therefore, the interworking fault of different xDSL transceivers, i.e., an xTU-C and an xTU-R can be solved effectively, thereby simplifying the process flow and giving convenience for operators and telecommunication device maintenance personnel, with work load and difficulties reduced, efficiency improved, and cost saved.

### BRIEF DESCRIPTIONS OF THE DRAWINGS

FIG. 1 is a schematic diagram of an xDSL system reference model in the related art;

FIG. 2 is a schematic diagram of an initialization process for an xDSL in the related art;

FIG. 3 is a schematic diagram of a system for diagnosing an interworking fault for the xDSL transceivers according to one embodiment;

FIG. 4 is a schematic diagram of a system for diagnosing an interworking fault for the xDSL transceivers according to one embodiment; and

FIG. 5 is a flowchart illustrating a method for diagnosing an interworking fault for the xDSL transceivers according to one embodiment.

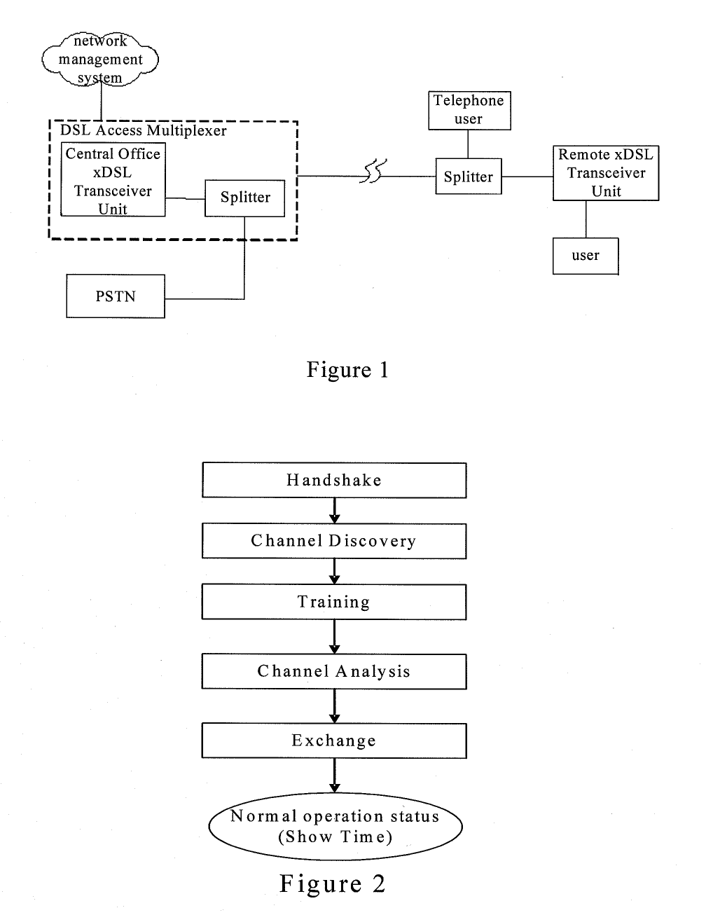

### DETAILED DESCRIPTIONS OF THE EMBODIMENTS

A cause corresponding to an interworking fault emerged in xDSL transceivers can generally be determined through analyzing an interaction message transmitted between an xTU-C and an xTU-R during an activation process for an xDSL line.

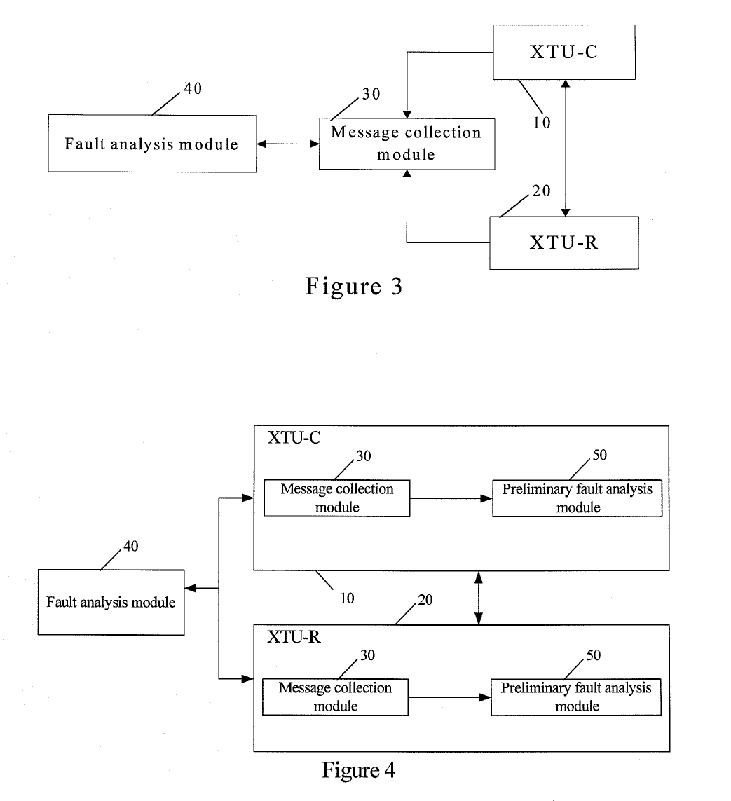

Referring to FIG. 3 and FIG. 4, a system for diagnosing an interworking fault for an xDSL transceivers according to an embodiment includes xDSL transceivers, which include an xTU-C 10 (i.e., an xDSL line card in a DSLAM device) and an xTU-R 20. The system further includes a message collection module 30 and a fault analysis module 40. The message collection module 30 is adapted to collect and save interaction messages transmitted between the xTU-C 10 and the xTU-R 20 during the activation process for an xDSL line, and the fault analysis module 40 is adapted to analyze the collected interaction messages to obtain a first diagnosis conclusion with respect to the interworking fault.

The system may also include a command input device or/and a diagnosis result display device (not shown). The command input device is adapted to transmit the received diagnosis command to the fault analysis module 40 and/or an preliminary fault analysis module in the xDSL transceiver, and the diagnosis result display device is adapted to display for a user a diagnosis conclusion generated by the fault analysis module 40 and/or the preliminary fault analysis module.

Both the message collection module 30 and the fault analysis module 40 may be arranged outside the xDSL transceiver, as shown in FIG. 3; or both of them may be arranged in the xDSL transceiver (not shown); or the message collection module 30 is arranged in the xDSL transceiver, while the fault analysis module 40 is arranged outside the xDSL transceiver, as shown in FIG. 4.

In the case that the fault analysis module 40 is arranged outside the xDSL transceiver, the xDSL transceiver is also provided inside with a preliminary fault analysis module 50, as shown in FIG. 4. The preliminary fault analysis module 50 is adapted to analyze preliminarily the collected interaction message to obtain a second diagnosis conclusion with respect to the interworking fault. The second diagnosis conclusion is simpler and more preliminary than the first diagnosis conclusion. The fault analysis module 40 remotely analyzes the interaction message collected by the xDSL transceiver to obtain a first diagnosis conclusion with respect to the interworking fault. The first diagnosis conclusion with respect to the interworking fault is made by the fault analysis module 40 according to features and relations of the messages in a corresponding stage described in the xDSL standard.

The fault analysis module 40 may be a computer installed with interworking fault diagnosis software.

In the case that the fault analysis module 40 is arranged outside the xDSL transceiver, the fault analysis module 40 is connected to the xDSL transceiver directly or via a communication network which may be a fixed communication network or a wireless communication network and the like.

An xDSL transceiver according to one embodiment includes a message collection module adapted to collect and save interaction messages transmitted between an xTU-C and an xTU-R during an activation process for an xDSL line; and a fault analysis module adapted to analyze the collected interaction messages to obtain a first diagnosis conclusion with respect to an interworking fault.

The xDSL transceiver may further include a message viewing module for receiving an operation command, and displaying the interaction messages to allow a user to view and obtain the messages.

Further, as shown in FIG. 4, the xDSL transceiver 10 (or xDSL transceiver 20) includes a message collection module 30 adapted to collect and save an interaction message transmitted between an xTU-C 10 and an xTU-R 20 during the activation process for an xDSL line; and a preliminary fault analysis module 50 adapted to analyze preliminarily the collected interaction messages to obtain a second diagnosis conclusion with respect to the interworking fault.

The above xDSL transceivers 10 and 20 may further include a message viewing module for receiving an operation command, and displaying the interaction messages to allow a user to view and obtain the messages.

Each of the above two kinds of xDSL transceivers can serve as a Central Office xDSL Terminal unit (xTU-C) or a Remote xDSL Terminal Unit (xTU-R).

A method for diagnosing an interworking fault of the xDSL transceivers according to one embodiment includes:

step A: the message collection module collects and saves interaction messages transmitted between the xTU-C and the xTU-R during the activation process for an xDSL line;

step B: the preliminary fault analysis module and/or the fault analysis module analyze the collected interaction messages to obtain a first diagnosis conclusion with respect to the interworking fault.

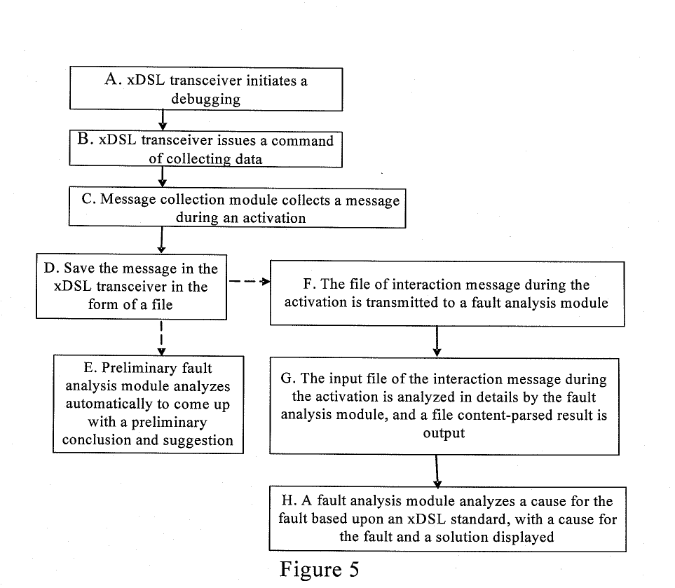

Referring to FIG. 5, an implementation of diagnosing an interworking fault of the xDSL transceivers according to one embodiment will be described in detail below taking an example with the message collection module located in the xDSL transceiver, the implementation includes:

Step A: the xDSL transceiver initiates a debugging;

Step B: The xDSL transceiver issues a command for collecting data;

Step C: The message collection module collects the interaction messages transmitted between the xTU-C and the xTU-R during the activation process for an xDSL line;

Step D: The interaction messages are saved in the storage medium of the xTU-C and the xTU-R. For example, the xDSL transceivers are an xDSL line card in the DSLAM device and an xTU-R, then the step D in particular includes: the xDSL line card transmits, via an internal management path of the DSLAM device, the interaction messages to a main control card management unit in the DSLAM device, and saves the interaction messages in the storage medium in the main control card of the Central Office device; the xTU-R saves the interaction messages in the storage medium of the xTU-R; the xDSL transceivers provides an operation command to allow a user to obtain and view the interaction messages. Here, the interaction messages are saved in the form of a file is only an embodiment, while in practice, the saving can be performed in other forms.

Step E: the preliminary fault analysis module analyzes preliminarily the collected interaction messages to obtain a second diagnosis conclusion with respect to the interworking fault. The second diagnosis conclusion is simpler and more preliminary than the first diagnosis conclusion, for example, the second diagnosis conclusion may include that a configuration parameter is unreasonable, or a standard parameter is not supported by the device and so on;

Step F: If the fault can not be resolved in step E, the file of the interaction messages is transmitted to the fault analysis module by the device maintenance personnel;

Step G: The file of the interaction messages is analyzed in detail by the fault analysis module, and the time for receiving/sending each of the interaction messages transmitted during the activation process, the type of the message, the current stage of the activation, and content of main parameters contained in the message and the like are displayed via a friendly visual interface to allow an analysis by a user. That is, before the fault analysis module determines a final first diagnosis conclusion with respect to the interworking fault, the time for receiving/sending each of the interaction messages transmitted during the activation process, the type of the message, the current stage of the activation, and content of main parameters contained in the message and the like can also be displayed.

Step H: The fault analysis module judges the cause for the interworking fault according to features and relations of messages in a corresponding stage described in the xDSL standard, to obtain the first diagnosis conclusion with respect to the interworking fault including, for example, whether a stage time does not comply with the xDSL standard, whether the xTU-C or xTU-R does not support the characteristic required by a user, and whether the configured parameters can not be achieved together and the like. Finally, the cause for the xDSL interworking fault and available measures are prompted via a friendly interface, to which a user can refer so as to resolve the fault.

By using the system and method for diagnosing an interworking fault of xDSL transceivers according to the embodiments, the fault can be located rapidly and the solution can be proposed, so as to resolve effectively the interworking fault between different xDSL transceivers, i.e. the xTU-C and the xTU-R, which brings convenience for the telecommunication service operators and the telecommunication device maintenance personnel and reduces the cost.

The above are merely preferred embodiments of the invention presented for the purpose of illustrating the present invention and are not intended to limit the scope of the invention. Any modifications, equivalents, and improvements without departing from the spirit and principle of the invention are intended to be within the claimed scope of the invention.

What is claimed is:

1. A device for a digital subscriber line (DSL), comprising:
a message collection module adapted to collect interaction messages transmitted between a Central Office xDSL Terminal unit (xTU-C) and a Remote xDSL Terminal Unit (xTU-R) during an activation process for an xDSL line; and
a fault analysis module adapted to analyze the collected interaction message to obtain a diagnosis conclusion with respect to an interworking fault.

2. The device according to claim 1, wherein the fault analysis module is adapted to analyze the collected interaction messages according to characteristic and relations of the interaction messages in a corresponding stage described in an xDSL standard to obtain the diagnosis conclusion.

3. The device according to claim 1, wherein the device is a line card.

4. The device according to claim 1, wherein the device is a digital subscriber line access multiplexer.

5. A diagnosis device for a digital subscriber line (DSL), comprising:
a message collection module adapted to communicate with a Central Office DSL Terminal Unit (xTU-R) and a Remote DSL Terminal Unit (xTU-C), and collect interaction messages transmitted between the xTU-C and the xTU-R during an activation process for an xDSL line; and
a fault analysis module adapted to analyze the collected interaction message to obtain a diagnosis conclusion with respect to a interworking fault.

6. The diagnosis device according to claim 5, wherein the fault analysis module is adapted to analyze the collected interaction messages according to characteristic and relations of the interaction messages in a corresponding stage described in an xDSL standard to obtain the diagnosis conclusion.

7. The diagnosis device according to claim 5, further comprising a message viewing module adapted to receive an operation command, and display the interaction messages.

8. A system for diagnosing an interworking fault for a digital subscriber line, comprising:
a message collection module, a fault analysis module, an xTU-C and an xTU-R, wherein the message collection module is in communication with the xTU-C and the xTU-R, the message collection module is adapted to collect interaction messages transmitted between the xTU-C and the xTU-R during an activation process for an xDSL line;
the fault analysis module is adapted to analyze the collected interaction messages to obtain a diagnosis conclusion with respect to an interworking fault.

9. The system according to claim 8, wherein both the message collection module and the fault analysis module are integrated in the xTU-C.

10. The system according to claim 8, wherein the message collection module is integrated in the xTU-R.

11. The system according to claim 10, wherein the xTU-R further comprises a preliminary fault analysis module adapted to analyze the collected interaction messages to obtain a preliminary diagnosis conclusion with respect to the interworking fault.

12. The system according claim 8, wherein the diagnosis conclusion with respect to the interworking fault is made by the fault analysis module according to characteristic and relations of the interaction messages in a corresponding stage described in an xDSL standard.

13. The system according to claim 8, further comprising a command input device and a diagnosis result display device, wherein the command input device is adapted to transmit a diagnosis command to the fault analysis module; and
the diagnosis result display device is adapted to display the diagnosis conclusion.

14. A method for diagnosing an interworking fault of a digital subscriber line, comprising:
collecting interaction messages transmitted between an xTU-C and an xTU-R during an activation process for an xDSL line; and
analyzing the collected interaction messages to obtain a diagnosis conclusion with respect to the interworking fault.

15. The method according to claim 14, comprising:
initiating a debugging, and issuing a command for collecting data;
collecting the interaction messages transmitted between the xTU-C and the xTU-R during the activation process for the xDSL line; and
saving the interaction messages into storage mediums of the xTU-C and the xTU-R.

16. The method according to claim 14, comprising:
analyzing the collected interaction messages according to characteristic and relations of the interaction messages in a corresponding stage described in an xDSL standard to obtain the diagnosis conclusion.
